(19) United States
(12) Patent Application Publication
(10) Pub. No.: US 2021/0109754 A1
(43) Pub. Date: Apr. 15, 2021

(54) CONTEXT BASED POWER SCHEME SELECTION

(71) Applicant: Lenovo(Singapore) Pte.Ltd, Singapore (SG)

(72) Inventors: John Carl Mese, Cary, NC (US); Nathan J. Peterson, Oxford, NC (US); Russell Van Blon, Raleigh, NC (US)

(21) Appl. No.: 16/600,167

(22) Filed: Oct. 11, 2019

(51) Int. Cl. G06F 9/30; G06F 9/48; G06F 11/30; G06F 1/32

(52) U.S. Cl. CPC G06F 9/30083; G06F 1/32; G06F 11/3062; G06F 9/4893

(57) ABSTRACT

A computer implemented method includes detecting a current context of a user device, comparing the current context of the user device to various power schemes associated with various saved contexts, selecting a first power scheme having a saved context commensurate with the current context, and saving the first power scheme as a current power scheme of the user device.

### BACKGROUND

Power settings on devices, such as laptop computers or tablets are usually set at one point in time and not changed unless a user modifies the power settings. Static time-outs work for many power settings. Some devices change power settings according to a static “low” power mode or battery saver mode in order to extend the length of time a battery will provide power. The remaining charge of a battery may be presented to the user in terms of a percentage of battery charge remaining or a time remaining prior to needing to charge the battery. A Game Mode may also be used to modify central processing unit (CPU) parameters when a game is launched. Otherwise, modifications to power are typically all-on or all-off.

### SUMMARY

A computer implemented method includes detecting a current context of a user device, comparing the current context of the user device to various power schemes associated with various saved contexts, selecting a first power scheme having a saved context commensurate with the current context, and saving the first power scheme as a current power scheme of the user device.

### BRIEF DESCRIPTION OF THE DRAWINGS

FIG. 1 is a block diagram of a system for selecting power schemes for a user device based on a detected context according to an example embodiment.

FIG. 2 is a flowchart illustrating a method for selecting power schemes for a user device based on a detected context according to an example embodiment.

FIG. 3 is a flowchart illustrating a computer implemented method of creating various power schemes that associated with various saved contexts according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system.” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Power settings on many computerized devices are “set it and forget it”. For example, if you change the behavior of a PC laptop when closing the lid, such as disabling sleep, then the system will stay in a higher power state until the user manually changes the system state. This may be desirable during the work day as a user moves between meetings. However, when the user goes home, the system will stay awake until some long time out before going to a lower power state. What is needed is a more intelligent way to manage power settings like this based on the context of the user.

Static time-outs work for some power settings. Some devices change power settings according to a static “low” power battery saver state or mode in order to extend the final percentage points of battery. Some applications may change power setting in response to execution or being launched. Otherwise, modifications are typically all-on or all-off.

In various embodiments of the present application, a software agent changes a power policy/scheme of a device based on a change in context of the user device. The desired setting could be learned over time, confirmed by the user, or a combination thereof. The idea is to record the context when a user changes a setting (or several) and identify when the context changes. The power scheme settings are modified or restored when the context changes again according to the learned or confirmed state. Power settings such as sleep setting, screen brightness, WiFi/Bluetooth/hotspot, CPU frequency, or other power adjustment could be controllable when the context changes based on several factors: +Location (Example: User disables S3 sleep on lid close only at work)+History (Example: User disables CPU throttling when performing rendering tasks). The history can include app usage, charging history (time or depth of last charge), time of day+User (Example: Brightness preferred by one user vs another on a shared tablet)+Surrounding devices (way to detect different context without relying on above factors)+Hybrid or a combination of all these factors. Example: these three devices at a particular park historically means 3 hours of Pokémon hunting so lower brightness, cap CPU frequency, switch usual device to hotspot others to tether, and disable screen timeouts. These settings may serve to conserve battery power to extend the time to game can be enjoyed, while still providing a good user experience by making sure the screen stays on while participating.

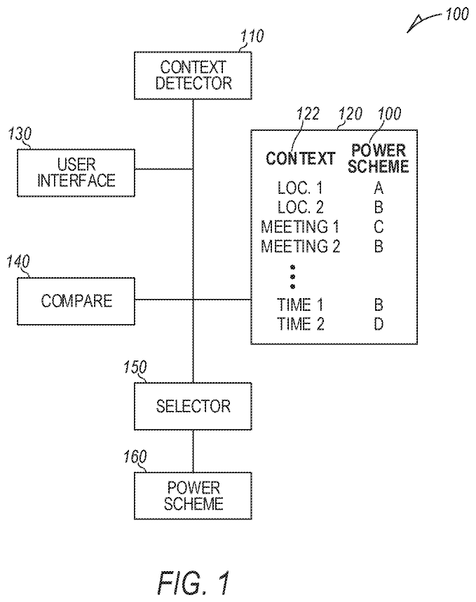

FIG. 1 is a block diagram of a system 100 for selecting power schemes for a user device based on a detected context. System 100 includes a context detector 110 that is configured to detect a context of a user device. User devices may include laptop computers, tablets, virtual or augmented reality headsets, or other battery power devices. The context can include a variety of factors as described above. Rather that just the opening of a particular application, the context has more to do with a location of the user, a closing or opening of a lid of the user device, switching to a different user, time of day, time or depth of charge, activity of the user, or combinations thereof. Thus, the application need not be programmed to switch power modes. Rather, the overall context of the device and user activity may be used to place the device in a power mode that makes use of the device more convenient for the user.

Various contexts are shown in a context data structure 120 in column 122. A list of contexts is provided with labels comprising LOC 1, LOC 2, Meeting 1, Meeting 2 . . . Time 1, and Time 2. Further contexts may include closing a lid on the user device, a user changing a power setting prior to executing certain tasks, charging history, or combinations thereof. Each context is associated with a power scheme as shown in column 124. The corresponding power schemes comprise A, B, C, and D. Power schemes represented by the letters may include values for many different parameters of the user device as listed above, including, but not limited to screen brightness, CPU speed, CPU throttling, sleep mode, sleep timeouts, wireless settings, sleeping states, remaining battery life, and any other setting related to performance and usability associated with changing the rate of power utilization of the user device.

In one embodiment, a user interface is coupled to the data structure to facilitate selecting of power schemes, such as from a drop-down menu, for each context. For example, LOC. 1 is an identifier that may correspond to a work location, where the user wants to ensure that the user device is on even when a laptop lid is closed. Thus, the power scheme dynamically selected for a detected context of closing the lid at work may include disabling one or more sleep modes, such as S3, in a user device comprising a laptop. Note that the location may be identified by data, such as GPS coordinates, an address, or other indication of the location that can be utilized by a programmed computer to represent the location. The other contexts may be similarly represented by suitable data.

The system power state S3 is a third sleep state and usually results in the following: Suspend to RAM (context saved to RAM) In this state, the PC in standby and all fans, hard drivers and other devices are powered down into a sleep state. The hardware of the device has a latency of about two seconds, and the software resumes from the processor's reset vector, resulting in a fairly fast startup. There are various other known sleeping states for Windows® based systems, such as S1, S2, and S4 with varying degrees of power consumption, software resumption, hardware latency, and hardware context saving. S4 is known as the hibernate state, is the lowest-powered sleeping state, and has the longest wake-up latency. S0 is an awake state, but may have many different adjustable parameters, such as processor speed and screen brightness resulting in different levels of power consumption. S5 is a shutdown state. Other types of devices may have the same or different states and power schemes.

On detection of a change in context via context detector 110, a compare function 140 is coupled to receive the new context and compare the new context with the contexts 122 in data structure 120. In response to match being found, a selector 150 receives the associated power scheme 124, including parameters for various power settings, and stores the associated power scheme in a location 160 from which the user device executes the power scheme to control power consumption of the user device in accordance with the change in context. Note that while different sleep modes may be selected, the parameters associated with those modes may also be selected to further customize the power schemes.

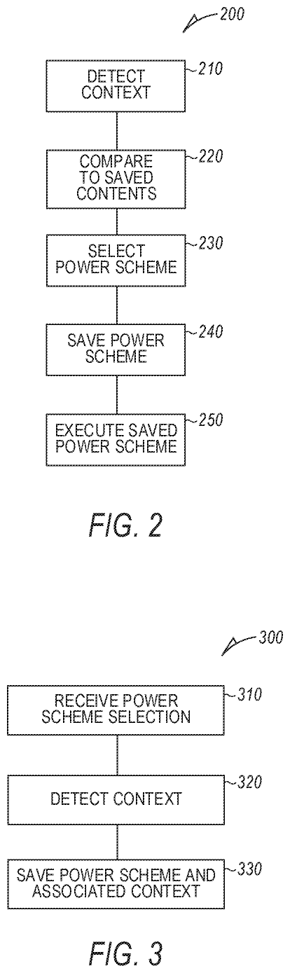

FIG. 2 is a flowchart illustrating a method 200 for selecting power schemes for a user device based on a detected context. Method 200 begins at operation 210 by detecting a current context of a user device. The context may be a complex context, such as the combination of two or more detected states of the device or devices or a simple context. The context may include whether or not a specific application is running. However, the specific application running may be an element of the context, and not a context that solely defines the power mode. Rather, the determination and selection of the power mode is independent of the specific application itself, as applications are already available which the power consumption of a device, such as by ensuring a display is in a bright state as opposed to a battery conserving state.

At operation 220 the current context of the user device is compared to various power schemes associated with various saved contexts. This comparison may be done by accessing data structure 120 in one embodiment and searching through the data structure for a matching context and associated power scheme. In other embodiments, the data structure may be indexed, allowing a faster comparison. Other methods of identifying a power scheme associated with a context may be used in further embodiments.

A first power scheme having a saved context commensurate with the current context is selected at operation 230. The first power scheme is saved as a current power scheme of the user device at operation 240. At operation 250 the saved first power scheme is executed to control power utilization of the user device.

FIG. 3 is a flowchart illustrating a computer implemented method 300 of creating various power schemes that associated with various saved contexts. Method 300 begins by receiving a selection of a power scheme by a user at operation 310. The selection may be based on a user changing a power scheme or based on a known context representative of use of the user device. In one embodiment, the user may be setting up a meeting. An option to select a power scheme for the meeting may be provided to the user. The option may include multiple common power setting options, such as different levels of sleep upon closing a laptop lid, different screen brightness options, different processor speed settings, as well as others.

At operation 320, the context associated with the selected power scheme is detected. The detection may include one or more of detecting the power scheme options selected by the user. In further embodiments, the detecting may include learning the power scheme currently in use for a current context. The selected power scheme and associated detected context are saved at operation 330 in data structure 120.

In one embodiment, the context comprises a meeting, which may be a recurring meeting. The user may have previously selected a power scheme for at least one of the meetings of the recurring meeting. The context associated with the meeting may be a subject of the meeting or an attendee of the meeting. For example, if a user closes a laptop a predetermined amount of time before the meeting, the power scheme associated with the meeting may be implemented.

The predetermined of amount time may be selected by the user or may be defaulted to a value between 1 and 15 minutes. The amount of time may be learned based on previous meetings in a recurring meeting and set in accordance with that amount of time, such as 5 minutes. If the meeting is known to be at a distant location, the predetermined amount of time may be set as a function of the travel time between a current location and the meeting location, using external services, such as Google Maps.

In a further embodiment, the context comprises a location and wherein the user previously selected a power scheme corresponding to the location. For example, the location may correspond to a user's home or at least one work location. The context may also include a time of day corresponding to a user usually performing an activity at such time of day. The context may also include a location of a further user device being within a selected range of the user device. The selected range may correspond to a short-range wireless protocol, such as at least one of Wi-Fi, Bluetooth, Bluetooth Low Energy (BLE), ZigBee, and Z-Wave.

The user device may include an internet of things device that is accessed by a user via a secondary device, wherein the context comprises a time of day, and wherein the power scheme of the user device causes the user device to be awake at that time of day.

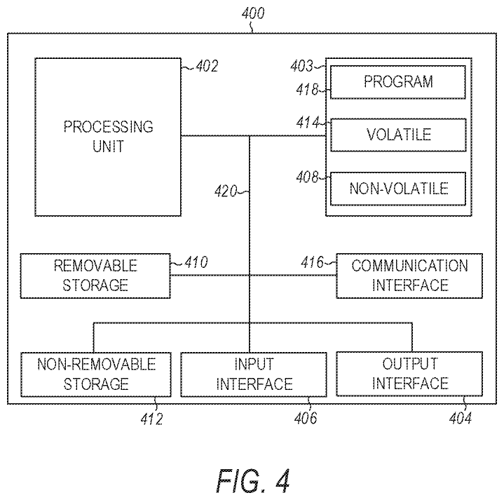

FIG. 4 is a block schematic diagram of a computer system 400 to implement and perform methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods and algorithms described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 418 along with the workspace manager 422 may be used to cause processing unit 402 to perform one or more methods or algorithms described herein.

### Examples

1. A computer implemented method includes detecting a current context of a user device, comparing the current context of the user device to various power schemes associated with various saved contexts, selecting a first power scheme having a saved context commensurate with the current context, and saving the first power scheme as a current power scheme of the user device.

2. The method of example 1 and further including executing the saved first power scheme to control power utilization of the user device.

3. The method of any of examples 1-2 wherein the various power schemes associated with various saved contexts are created by operations including receiving a selection of a power scheme by a user, detecting the context associated with the selected power scheme, and saving the selected power scheme and associated detected context.

4. The method of any of any of examples 1-3 wherein the context includes a meeting.

5. The method of example 4 wherein the meeting includes a recurring meeting and wherein the user previously selected a power scheme for at least one of the meetings of the recurring meeting.

6. The method of any of examples 4-5 wherein the context associated with the meeting includes a subject of the meeting.

7. The method of example 4 wherein the context associated with the meeting includes an attendee of the meeting.

8. The method of any of examples 1-4 wherein the context comprises a location and wherein the user previously selected a power scheme corresponding to the location.

9. The method of example 8 wherein the location corresponds to a user's home or at least one work location.

10. The method of any of examples 1-4 wherein the context includes a time of day corresponding to a user usually performing an activity at such time of day.

11. The method of any of examples 1-4 wherein the context includes a location of a further user device being within a selected range of the user device.

12. The method of example 11 wherein the selected range corresponds to a short-range wireless protocol.

13. The method of example 12 wherein the short-range wireless protocol includes at least one of Wi-Fi, Bluetooth, Bluetooth Low Energy (BLE), ZigBee. and Z-Wave.

14. The method of any of examples 1-13 wherein the user device includes an internet of things device that is accessed by a user via a secondary device, wherein the context comprises a time of day, and wherein the power scheme of the user device causes the user device to be awake at that time of day.

15. A machine-readable storage device has instructions for execution by a processor of a machine to cause the processor to perform operations to perform a method. The operations include detecting a current context of a user device, comparing the current context of the user device to various power schemes associated with various saved contexts, selecting a first power scheme having a saved context commensurate with the current context, and saving the first power scheme as a current power scheme of the user device.

16. The device of example 15 and further including executing the saved first power scheme to control power utilization of the user device.

17. The device of any of examples 15-16 wherein the various power schemes associated with various saved contexts are created by operations including receiving a selection of a power scheme by a user, detecting the context associated with the selected power scheme, and saving the selected power scheme and associated detected context.

18. The method of any of examples 15-17 wherein the context includes a recurring meeting and wherein the user previously selected a power scheme for at least one of the meetings of the recurring meeting and the context associated with the meeting includes a subject of the meeting or an attendee of the meeting.

19. A device includes a processor and a memory device coupled to the processor and having a program stored thereon for execution by the processor to perform operations. The operations include detecting a current context of a user device, comparing the current context of the user device to various power schemes associated with various saved contexts, selecting a first power scheme having a saved context commensurate with the current context, and saving the first power scheme as a current power scheme of the user device.

20. The device of example 19 and further including executing the saved first power scheme to control power utilization of the user device.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
detecting a current context of a user device;
comparing the current context of the user device to various power schemes associated with various saved contexts;
selecting a first power scheme having a saved context commensurate with the current context; and
saving the first power scheme as a current power scheme of the user device.

2. The method of claim 1 and further comprising executing the saved first power scheme to control power utilization of the user device.

3. The method of claim 1 wherein the various power schemes associated with various saved contexts are created by operations comprising:
receiving a selection of a power scheme by a user;
detecting the context associated with the selected power scheme; and
saving the selected power scheme and associated detected context.

4. The method of claim 1 wherein the context comprises a meeting.

5. The method of claim 4 wherein the meeting comprises a recurring meeting and wherein the user previously selected a power scheme for at least one of the meetings of the recurring meeting.

6. The method of claim 4 wherein the context associated with the meeting comprises a subject of the meeting.

7. The method of claim 4 wherein the context associated with the meeting comprises an attendee of the meeting.

8. The method of claim 1 wherein the context comprises a location and wherein the user previously selected a power scheme corresponding to the location.

9. The method of claim 8 wherein the location comprises a user's home or at least one work location.

10. The method of claim 1 wherein the context comprises a time of day corresponding to a user usually performing an activity at such time of day.

11. The method of claim 1 wherein the context comprises a location of a further user device being within a selected range of the user device.

12. The method of claim 11 wherein the selected range corresponds to a short-range wireless protocol.

13. The method of claim 12 wherein the short-range wireless protocol comprises at least one of Wi-Fi, Bluetooth, Bluetooth Low Energy (BLE), ZigBee, and Z-Wave.

14. The method of claim 1 wherein the user device comprises an internet of things device that is accessed by a user via a secondary device, wherein the context comprises a time of day, and wherein the power scheme of the user device causes the user device to be awake at that time of day.

15. A machine-readable storage device having instructions for execution by a processor of a machine to cause the processor to perform operations to perform a method, the operations comprising:
detecting a current context of a user device;
comparing the current context of the user device to various power schemes associated with various saved contexts;
selecting a first power scheme having a saved context commensurate with the current context; and
saving the first power scheme as a current power scheme of the user device.

16. The device of claim 15 and further comprising executing the saved first power scheme to control power utilization of the user device.

17. The device of claim 15 wherein the various power schemes associated with various saved contexts are created by operations comprising:
receiving a selection of a power scheme by a user;
detecting the context associated with the selected power scheme; and
saving the selected power scheme and associated detected context.

18. The method of claim 15 wherein the context comprises a recurring meeting and wherein the user previously selected a power scheme for at least one of the meetings of the recurring meeting and the context associated with the meeting comprises a subject of the meeting or an attendee of the meeting.

19. A device comprising:
a processor; and
a memory device coupled to the processor and having a program stored thereon for execution by the processor to perform operations comprising:
detecting a current context of a user device;
comparing the current context of the user device to various power schemes associated with various saved contexts;
selecting a first power scheme having a saved context commensurate with the current context; and
saving the first power scheme as a current power scheme of the user device.

20. The device of claim 19 and further comprising executing the saved first power scheme to control power utilization of the user device.
